(19) United States
(12) Patent Application Publication
(10) Pub. No.: US 2006/0014424 A1
(43) Pub. Date: Jan. 19, 2006

(54) Structure for reinforcement pin in electrical connector

(76) Inventor: Jang Beom Jin, Chungcheongnam-do (KR)

Correspondence Address: Stacey E Caldwell;Molex Incorporated, 2222 Wellington Court, Lisle, IL, 60532, US

(21) Appl. No.: 10/496,517

(22) PCT Filed: Dec. 11, 2002
(86) PCT No.: PCT/US02/39422

§ 371 Date: Mar. 14, 2005

(30) Foreign Application Priority Data
Dec. 11, 2001 (KR) 2001-78065

(51) Int. Cl. H01R 13/60

(52) U.S. Cl. 439/570

(57) ABSTRACT

A structure for a reinforcement pin (130) in an electrical connector (100) is disclosed. The connector includes a connector housing (110), connection pins (120) mounted in the housing for electrical connection with electrical contacts (210) on a printed circuit board (200), and a reinforcement pin (130) mounted on each side of a lower portion of a front surface of the connector housing (110). Mating parts (114) for receiving the reinforcement pins (130) therein are formed at lower sides of the connector housing, and include upper and lower mating grooves (114a, 114b) formed together. Each reinforcement pin (130) has upper and lower mating members (132,134) which correspond to the mating parts (114) in the connector housing (10), for insertion into and mating with a corresponding housing mating part. A portion of the front part of each lower mating groove (114b) has an open lower side. Portions of the reinforcement pins (130) project from the lower mating groove lower sides and are adapted for soldering to stationary contacts on the printed circuit board. When the connector (100) including the reinforcement pins (130) has been fixed to the printed circuit board (200) by soldering, the reinforcement pins (130) act to prevent the connection pins (120) from bending when the connector is exposed to impact or vibration.

### FIELD OF THE INVENTION

The present invention relates to a structure for a reinforcement pin in an electrical connector which is designed to prevent bending of an electrical contact in the connector.

### BACKGROUND OF THE INVENTION

Connectors are generally known in the art for establishing electrical connections between inputs and outputs of electronic devices such as notebook computers, camcorders, etc. Where such connectors are to be mounted to a printed circuit board, one or more reinforcement pins may be mounted on the connector housing and soldered to the circuit board to help secure the connector to the board and to relieve stresses acting on the connector terminal mating interfaces and solder connections. One example of a conventional reinforcement pin structure will be explained with reference to FIGS. 1 and 2 below. FIG. 1 is an exploded view of a female connector 10 incorporating a conventional reinforcement pin 16. FIG. 2 is a partial cutaway view of the connector of FIG. 1.

Referring to FIGS. 1 and 2, female connector 10 comprises a connector housing 12 having a mating hole 12a through which a male connector (not shown) is inserted and mating parts 12b formed generally in a “U” shape on sides of mating hole 12a; connection pins 14 each having a first electrical contact for electrical connection with an electrical contact 22 on a printed circuit board 20 and a second electrical contact for electrical connection with a mating contact (not shown) in a male connector; and reinforcement pins 16 for soldering to stationary contacts 24 on printed circuit board 20 to prevent bending of connection pins 14.

In conventional female connector 10, the first and second electrical contacts of connection pins 14 are disposed to extend forwardly from sides of a rear surface of the connector housing, and reinforcement pins 16 are mounted to lower sides of a front surface of connector housing 12. Each reinforcement pin 16 is configured in shape of a “U”, which corresponds to a mating part 12b having a complementary “U” shape formed at lower sides of the front surface of connector housing 12. In this configuration, an upper portion of reinforcement pin 16 is inserted into and mated with an upper portion of mating part 12b, and a lower portion of pin 16 abuts a lower surface of connector housing 12. That is, reinforcement pin 16, which is mated with respective mating part 12b in connector housing 12, is inserted into and mated to mating part 12b only at the upper portion of pin 16.

Conventional electrical connector 10 is secured to printed circuit board 20 by soldering the first electrical contacts of connection pins 14 and reinforcement pins 16 to electrical contacts 22 and stationary contacts 24, respectively, on printed circuit board 20. As explained above, according to the conventional reinforcement pin structure, each reinforcement pin 16 is configured to have a “U” shape and to be mated with a portion of the connector housing also having a “U” shape. The lower portion of each reinforcement pin 16 is exposed to a lower surface of the connector housing, so that mating forces are reduced, producing some shaking of the reinforcement pin. Accordingly, the connection pins can be bent due to shaking of the connector housing when the male connector is electrically coupled to the female connector.

Further, the electrical connection between the electrical contacts of the printed circuit board and the connection pins can be disrupted due to bending of the connection pins. In addition, with reinforcement pins having the conventional structure described above, it is difficult to accurately form the corresponding mating part on the connector housing. That is, as the connector housing is very small in size, it is very difficult to configure the mating part on the connector housing in a “U” shape which corresponds in shape to the reinforcement pin.

### SUMMARY OF THE INVENTION

Accordingly, an object of the present invention is to provide a connector reinforcement pin structure configured so that it can penetrate into one side of a mating part in a connector housing and engage a mating part in a connector housing, thereby facilitating location of the reinforcement pin in the mating part of the connector housing.

Another object of the present invention is to provide an improved reinforcement pin structure which will aid in preventing bending of connection pins mounted in the connector.

Another object of the present invention is to provide a connector reinforcement pin structure enabling a connector to be securely fixed to a printed circuit board by locating and mounting the reinforcement pin in a mating part in the connector housing.

Yet another object of the present invention is to provide a connector reinforcement pin structure which enables accurate positioning of a connection pin on a printed circuit board when the reinforcement pin is engaged with a mating part in a connector housing.

Yet another object of the present invention is to provide a connector reinforcement pin structure in which a mating part of the reinforcement pin can be accurately sized by configuring the reinforcement pin to be inserted so as to penetrate into and engage one side of the mating part of the connector housing.

In order to accomplish these objects, a connector reinforcement pin structure is provided for mounting on an electrical connector, the connector including a connector housing, connection pins mounted in the connector housing for electrical contact with contacts in a printed circuit board, and reinforcement pins which abut lower portions of a front surface of the connector housing and for solder attachment to stationary contacts on the printed circuit board to reinforce the connection pins.

Mating parts for each reinforcement pin are formed at lower sides of the connector housing and include upper and lower mating grooves formed together, with a portion of a front part of the lower mating groove having an open lower side.

Each reinforcement pin has upper and lower mating members which correspond to the mating part in the connector housing, and each reinforcement pin is inserted into and mated with the mating part of the connector housing. Further, a sill is formed between a front end of the reinforcement pin lower mating member and a lower portion of the lower mating member. The lower portion of the lower mating member is soldered to a corresponding stationary contact on the printed circuit board. Also, a raised spot is formed on a lower surface of the upper mating member for penetrating into a lower surface of the lower mating groove, to fix and locate the reinforcement pin on the mating part when the reinforcement pin is inserted into and mated with the mating part in the connector housing.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded view showing a prior art reinforcement pin structure employed in an electrical connector;

FIG. 2 is a partial cutaway view of the connector of FIG. 1 shown in an assembled state;

FIG. 3 is a perspective view showing a reinforcement pin for an electrical connector in accordance with the present invention;

FIG. 4 is a side view of the reinforcement pin of FIG. 3;

FIG. 5 is an exploded view of a connector incorporating the reinforcement pin structure of FIG. 3, in accordance with the present invention;

FIG. 6 is a perspective view of a rear portion of the electrical connector of FIG. 5 shown in an assembled state;

FIG. 7 is a sectional view of the reinforcement pin structure of FIG. 1 mated with a mating portion of a connector housing in accordance with the present invention;

FIG. 8 is a perspective view of the connector of FIG. 5 showing alignment of the connector contacts and reinforcement pins with corresponding contacts on a printed circuit board; and

FIG. 9 is a plan view of the connector of FIG. 8 attached to the printed circuit board.

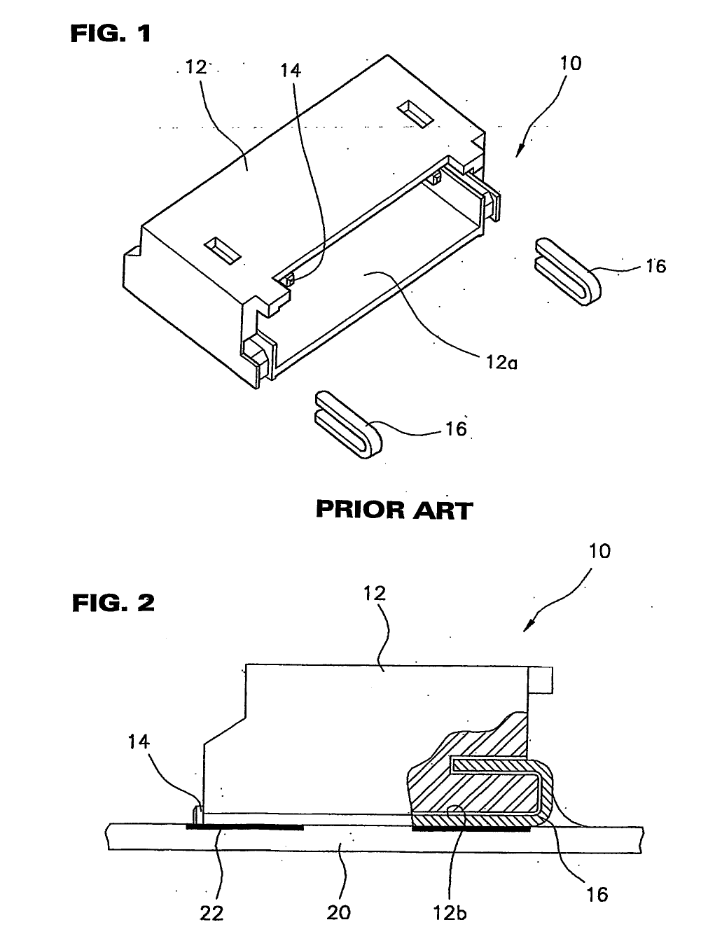

### DETAILED DESCRIPTION OF THE INVENTION

Hereinafter, embodiments of the present invention will be described with reference to the accompanying drawings. In the following description and drawings, the same reference numerals are used to designate the same or similar components, and so repetition of the description of the same or similar components will be omitted.

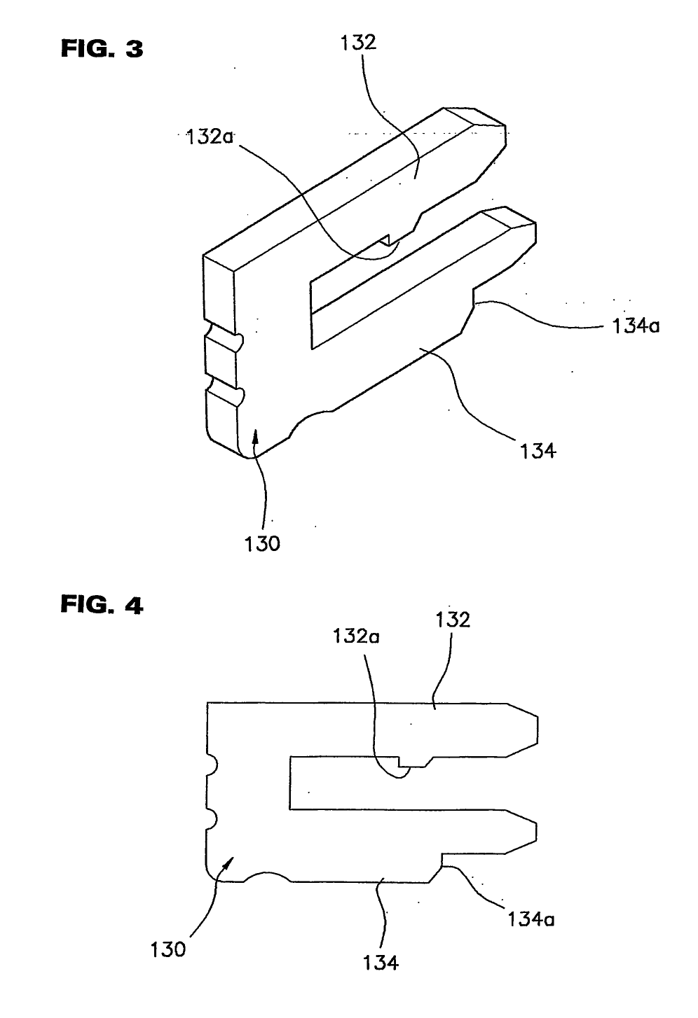

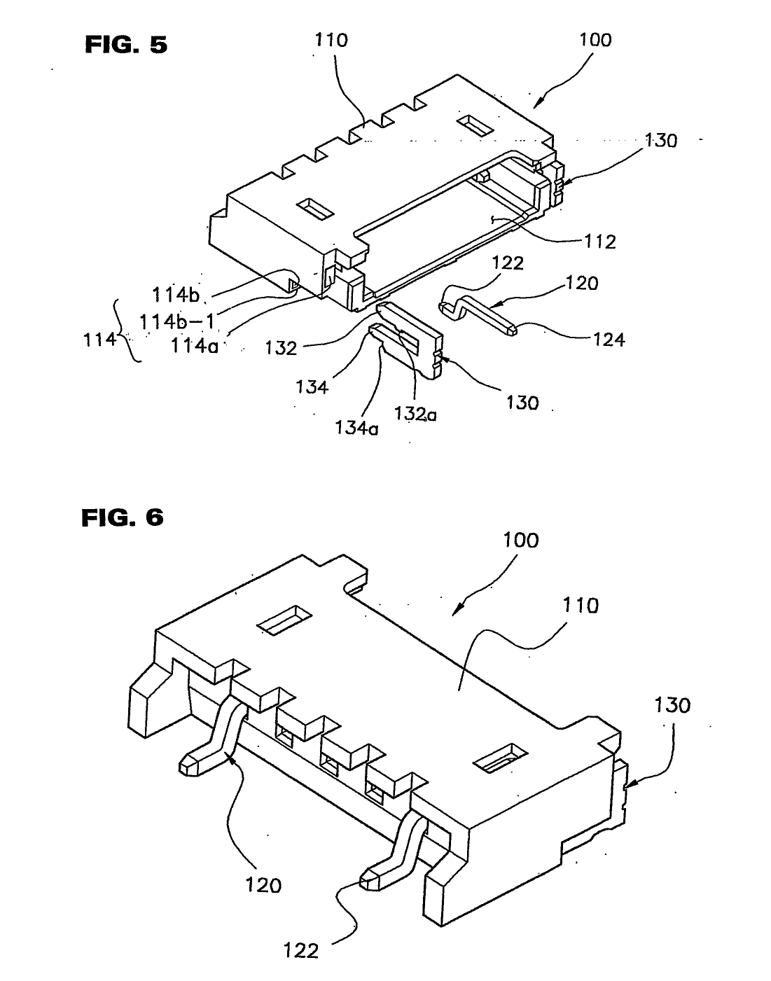

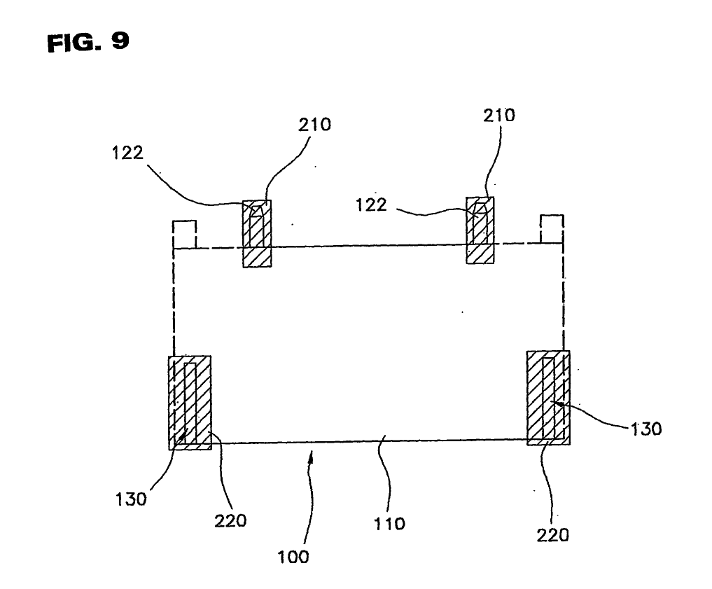

FIGS. 3 to 9 show a female connector 100 in accordance with the present invention. Referring to FIGS. 5 and 9, female connector 100 includes a connector housing 110 having a mating hole 112 through which a male connector (not shown) is inserted and mating parts 114 for reinforcement pins 130 formed at sides of the housing on a front surface thereof. Connection pins 120 are provided, each pin 120 having a first electrical contact 122 for electrical connection with an electrical contact 210 on a printed circuit board 200 by soldering, and a second electrical contact 124 for mating with a complementary contact in a male connector. Reinforcement pins 130 are fixed to stationary contacts 220 on the printed circuit board 200 by soldering when pins 130 are mated with the mating parts 114 in the connector housing 110, in order to prevent bending of the connection pins 120 when connector 100 is exposed to impact or vibration.

Referring to connector housing 110 as seen in FIGS. 3, 5 and 7, mating part 114 for reinforcement pin 130 includes upper and lower mating grooves 114a, 114b formed together at lower portions of the connector housing 110.

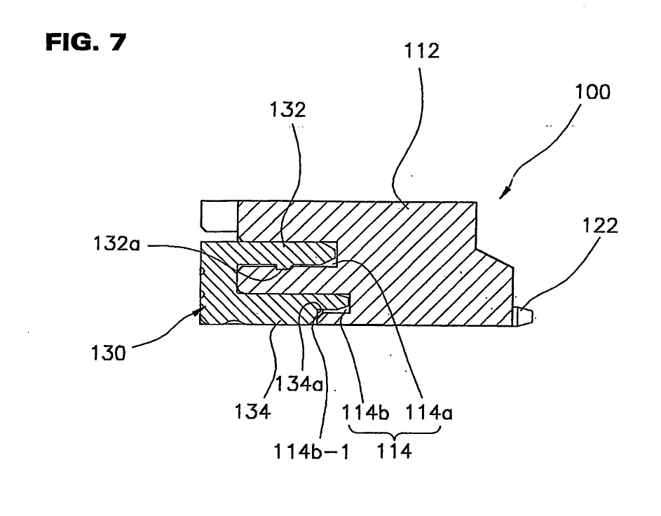

Referring to FIGS. 5 and 7, the upper mating grooves 114a of the mating part 114 are formed at sides of the connector housing 110 as through holes, and the lower mating grooves 114b have open lower portions at a front side of housing 110. Lower mating groove 114b is open at a lower portion thereof so that a lower surface of a reinforcement pin lower mating member 134 can be soldered to the stationary contact 220 of the printed circuit board 200. An engaging jaw 114b-1 is formed proximate a bottom surface of housing 110 for abutting a sill 134a formed on lower mating member 134 of reinforcement pin 130, in a manner to be described in detail later.

Referring to FIGS. 3 and 7, reinforcement pins 130 are each configured to have upper and lower mating members 132, 134, respectively, which correspond to the connector housing mating parts 114.

As shown in FIG. 7, upper mating member 132 and lower mating member 134 of reinforcement pin 130 are formed together in a “U” shape to mate with upper and lower mating grooves 114a, 114b respectively of mating part 114.

A sill 134a is formed between a front end of lower mating member 134 and a portion of reinforcement pin 130 to be secured to stationary contact 220 of printed circuit board 200. Abutment of sill 134a with engaging jaw 114b-1 during insertion of reinforcement pin 130 into connector housing 110 indicates that reinforcement pin 130 is fully engaged with mating part 114. Lower mating member 134 also has a portion which is exposed and which is configured for attachment to stationary contact 220 of printed circuit board 200 by soldering.

Further, a stationary raised spot 132a is formed on a lower surface of upper mating member 132 to penetrate into a lower surface of housing upper mating groove 114a during reinforcement pin insertion, thereby fixing and locating reinforcement pin 130 in mating part 114 when reinforcement pin 130 is inserted into and mated with mating part 114.

A process for mating reinforcement pin 130 with mating part 114 of connector 100 is explained below.

Firstly, upper and lower mating members 132,134 of reinforcement pin 130 are aligned with upper and lower mating grooves 114a, 114b, respectively, of the mating part 114. Then, upper and lower mating members 132, 134 are pushed forward into respective mating grooves 114a, 114b causing raised flange 132a, which is formed at a lower surface of upper mating member 132 of reinforcement pin 130, to penetrate into a lower surface of upper mating groove 114a to locate and secure reinforcement pin 130 within housing 110. During insertion of reinforcement pin 130 into housing 110, when sill 134a formed on the lower mating member 134 abuts engaging jaw 114b-1 formed on lower mating groove 114b, reinforcement pin 130 is completely mated with the mating part 114. If sill 132a does not abut engaging jaw 114b-1, reinforcement pin 130 is not completely mated with the mating part.

Thus, according to the present invention as described above, when each mating member 132,134 of reinforcement pin 130 is inserted into lower and upper mating grooves 114a, 114b of a mating part 114, stationary raised spot 132a formed at the lower surface of upper mating member 134 penetrates into the lower surface of upper mating groove 114a to fix and locate reinforcement pin 130 to mating part 114. Also, an end of lower mating member 134 is inserted into, and mated with, the lower mating groove 114b of the mating part 114.

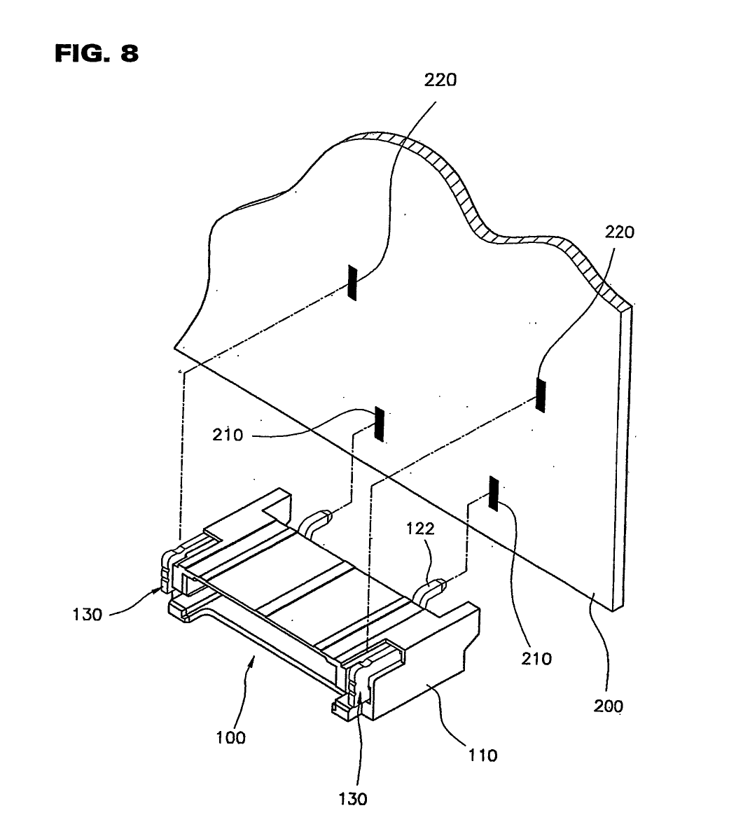

Referring to FIGS. 8 and 9, after assembly the connector 100 is then fixed to the printed circuit board 200 by aligning second electrical contacts 122 and reinforcement pins 130 with corresponding ones of electrical contacts 210 and stationary contacts 220, respectively, and then soldering second electrical contacts 122 and reinforcement pins 130 to corresponding contacts on circuit board 200. Accordingly, when connector 100 (including reinforcement pins 130) has been fixed to the printed circuit board 200 by soldering, reinforcement pins 130 act to prevent connection pins 120 from bending when connector 100 is exposed to impact or vibration.

The following advantages are achieved by the present invention as described above. as follows.

Firstly, as the reinforcement pins are configured to penetrate into and engage the mating parts of the connector housing, the reinforcement pins can be securely engaged with the mating parts in the connector housing, thus enabling the reinforcement pins to prevent bending of the connection pins.

Secondly, as the reinforcement pins are securely engaged with the mating parts in the connector housing as described above, the reinforcement pins aid in securing the connector to the printed circuit board when the reinforcement pins are soldered to the board.

In addition, as the reinforcement pins are configured to securely engage the mating parts of the connector to help prevent bending of the connection pins, good electrical contact between the connection pins and the printed circuit board can be achieved.

Lastly, as the reinforcement pins are configured to penetrate into and securely engage the mating parts of the connector, the mating parts formed in the connector housing for the reinforcement pins can be more accurately shaped to conform to the shape of the reinforcement pins, and the reinforcement pins can be more easily assembled to the mating parts in the connector housing.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A structure for a reinforcement pin (130) in an electrical connector (100), the connector including a connector housing (110), connection pins (120) for electrical attachment to electrical contacts (210) on a printed circuit board (200), and a reinforcement pin (130) mounted on each side of the housing for attachment to the printed circuit board, the structure for the reinforcement pin (130) characterized in that
the connector housing (110) includes a mating part (114) for each reinforcement pin formed at a lower side of the connector housing, the mating part having an upper and lower mating groove (114a,114b) extending partially through the connector housing (110), a portion of a front part of the lower mating groove (114b) having an open lower side, and the reinforcement pin (130) having upper and lower mating members (132,134) which correspond to the upper and lower mating grooves (114a,114b) in the connector housing, for insertion into and mating with the upper and lower mating grooves, respectively.

2. The structure for the reinforcement pin (130) according to claim 1, wherein a sill (134a) is formed between a front end of the reinforcement pin lower mating member (134) and a portion of the reinforcement pin to be secured to the printed circuit board (200) for indicating a fully mated condition between the reinforcement pin and the mating part, and wherein a portion of the lower mating member (134) is adapted to be soldered to a stationary contact on the printed circuit board.

3. The structure for the reinforcement pin according to claim 1, wherein a raised spot (132a) is formed on a lower surface of the upper mating member (132) for penetrating into a lower surface of the upper mating groove (114a), to secure the reinforcement pin (130) in the mating part when the reinforcement pin is inserted into and mated with the mating part in the connector housing (110).
